(19) United States
(12) Patent Application Publication
(10) Pub. No.: US 2025/0100583 A1
(43) Pub. Date: Mar. 27, 2025

(54) SYSTEMS AND METHODS FOR GENERATING EGO VEHICLE DRIVER-BASED GUIDANCE

(71) Applicant: Toyota Motor Engineering & Manufacturing North America, Inc., Plano, TX (US)

(72) Inventors: Seyhan Ucar, Mountain View, CA (US); Sachin Sharma, Kalamazoo, MI (US); Yongkang Liu, McKinney, TX (US); Emrah Akin Sisbot, Menlo Park, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/472,665

(22) Filed: Sep. 22, 2023

(51) Int. Cl. B60W 60/00; B60W 50/00; G08G 1/16

(52) U.S. Cl. CPC B60W 60/0016; B60W 50/0097; G08G 1/16; B60W 2552/10; B60W 2554/4046; B60W 2554/408; B60W 2556/10

(57) ABSTRACT

Systems, methods, and other embodiments described herein relate to providing vehicle guidance based on a classification of an unsafe driving behavior. In one embodiment, a method includes detecting an unsafe driving behavior of a vehicle in a vicinity of an ego vehicle and classifying the unsafe driving behavior based on characteristics of the unsafe driving behavior. The method also includes simulating candidate ego vehicle responses to the unsafe driving behavior based on 1) a classification of the unsafe driving behavior and 2) a profile of an ego vehicle driver. The method also includes generating guidance for the ego vehicle based on a selected vehicle response.

### TECHNICAL FIELD

The subject matter described herein relates, in general, to providing vehicle guidance and, more particularly, to providing anti-collision vehicle guidance based on a classification of unsafe driving behavior and an ego vehicle driver profile.

### BACKGROUND

Vehicles have dotted roads across the globe for many years. As the number of vehicles on roads rises, so does the potential for dangerous collisions between vehicles. Some vehicles include sensor systems that facilitate the safe navigation of roadways and the safe use of roadways by multiple vehicles. For example, vehicles may have sensors to perceive other vehicles along a roadway. As a specific example, a vehicle may be equipped with a light detection and ranging (LIDAR) sensor that uses light to scan the surrounding environment. At the same time, logic associated with the LIDAR analyzes acquired data to detect the presence of vehicles or objects and features of the surrounding environment. In further examples, additional/alternative sensors such as cameras may be implemented to acquire information about the surrounding environment from which a system derives awareness about aspects of the surrounding environment. This sensor data can be useful in various circumstances for improving perceptions of the surrounding environment so that systems such as autonomous driving and driver assistance systems can perceive the noted aspects and accurately plan and navigate accordingly. In one example, navigation systems and autonomous driving systems may use this sensor data to avoid collisions with other vehicles.

In general, the further awareness developed by the vehicle about a surrounding environment, the better a driver can be supplemented with information to assist in driving and/or the better an autonomous system can control the vehicle to avoid collisions with other vehicles.

### SUMMARY

In one embodiment, example systems and methods relate to a manner of improving vehicle guidance by basing such on a classification of an unsafe driving behavior and a profile of an ego vehicle driver.

In one embodiment, a guidance generation system for providing vehicle guidance based on a classification of an unsafe driving behavior and a profile of an ego vehicle driver is disclosed. The guidance generation system includes one or more processors and a memory communicably coupled to the one or more processors. The memory stores instructions that, when executed by the one or more processors, cause the one or more processors to detect an unsafe driving behavior of a vehicle in a vicinity of an ego vehicle and classify the unsafe driving behavior based on characteristics of the unsafe driving behavior. The memory also stores instructions that, when executed by the one or more processors, cause the one or more processors to simulate candidate ego vehicle responses to the unsafe driving behavior based on 1) a classification of the unsafe driving behavior and 2) a profile of an ego vehicle driver. The memory also stores instructions that, when executed by the one or more processors, cause the one or more processors to generate guidance for the ego vehicle based on a selected vehicle response.

In one embodiment, a non-transitory computer-readable medium for providing vehicle guidance based on a classification of an unsafe driving behavior and a profile of an ego vehicle driver and including instructions that, when executed by one or more processors, cause the one or more processors to perform one or more functions is disclosed. The instructions include instructions to detect an unsafe driving behavior of a vehicle in a vicinity of an ego vehicle and classify the unsafe driving behavior based on characteristics of the unsafe driving behavior. The instructions also include instructions to simulate candidate ego vehicle responses to the unsafe driving behavior based on 1) a classification of the unsafe driving behavior and 2) a profile of an ego vehicle driver. The instructions also include instructions to generate guidance for the ego vehicle based on a selected vehicle response.

In one embodiment, a method for providing vehicle guidance based on a classification of an unsafe driving behavior and a profile of an ego vehicle driver is disclosed. In one embodiment, the method includes detecting an unsafe driving behavior of a vehicle in a vicinity of an ego vehicle and classifying the unsafe driving behavior based on characteristics of the unsafe driving behavior. The method also includes simulating candidate ego vehicle responses to the unsafe driving behavior based on 1) a classification of the unsafe driving behavior and 2) a profile of an ego vehicle driver. The method also includes generating guidance for the ego vehicle based on a selected vehicle response.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a guidance generation system that is associated with providing vehicle guidance based on a classification of an unsafe driving behavior and a profile of an ego vehicle driver.

FIG. 3 illustrates one embodiment of the guidance generation system of FIG. 2 in a cloud-computing environment.

FIG. 4 illustrates a flowchart for one embodiment of a method that is associated with providing vehicle guidance based on a classification of an unsafe driving behavior and a profile of an ego vehicle driver.

FIGS. 5A and 5B illustrate digital twin simulations and possible outcomes of different suggested guidance.

FIGS. 6A-6C illustrate an example of providing vehicle driver assistance based on a first classification of an unsafe driving behavior and a profile of an ego vehicle driver.

FIGS. 7A-7C illustrate an example of providing vehicle driver assistance based on a second classification of an unsafe driving behavior and a profile of an ego vehicle driver.

### DETAILED DESCRIPTION

Systems, methods, and other embodiments associated with improving anti-collision driver assistance systems are disclosed herein. As previously described, the number of vehicles that populate the roadways of the globe is increasing. This makes vehicular travel more complex and increases the likelihood of potentially dangerous collisions between vehicles. The complexity and likelihood of collisions increase as drivers on the road exhibit unsafe driving behavior, which is behavior that abuses or jeopardizes the safety of others. Examples of unsafe driving behaviors include 1) aggressive driving, where a driver tailgates or cuts between vehicles; 2) distracted driving, where a driver swerves within a lane and exhibits delayed reaction times; and 3) reckless driving, where a driver runs red lights and changes lanes without signaling. While particular reference is made to certain types of unsafe driving behavior, other unsafe driving behaviors similarly enhance the possibility of vehicular collision or other undesirable results.

To combat this issue, modern vehicles can monitor nearby vehicles (e.g., vehicles behind an ego vehicle) and detect unsafe driving behaviors (e.g., distracted, aggressive, reckless) of the nearby vehicles. When unsafe driving is detected, the ego vehicle can 1) guide a driver of a manually driven ego vehicle or 2) autonomously control the ego vehicle to reduce the risk of a collision.

However, if not appropriately managed, the anti-collision guidance (e.g., navigation instruction or autonomous control) can itself place the ego vehicle and passengers in a dangerous situation. For example, a suggestion that an ego vehicle change lanes may cause another collision (e.g., a side crash) as the aggressive driver may swerve into the lane while the ego vehicle changes to that lane. In another example, guidance instructing an ego vehicle to reduce its speed responsive to a detected unsafe driving behavior may cause a rear-end collision as a distracted driver in a following vehicle (who has delayed reaction times) may not observe the ego vehicle slowing down.

As such, the system of the present application reduces the likelihood that a suggested anti-collision guidance maneuver will increase the likelihood of another collision. For example, given the first example above, rather than instructing an ego vehicle to change lanes, the system of the present application may, responsive to detecting the nearby vehicle exhibits aggressive driving, recommend the ego vehicle remain in its current lane and maintain a current speed. In the second example above, rather than instructing an ego vehicle to slow down, the system of the present application may, responsive to detecting the nearby vehicle exhibits distracted driving, recommend the ego vehicle change lanes. As such, the present system mines the characteristics of a detected unsafe driving behavior to classify or characterize the unsafe driving behavior. The system then uses the inferred characteristics and the ego vehicle driver profile to simulate the candidate driving suggestions and generate guidance to ensure the safety of vehicles on the roadway.

Vehicles can run any type of unsafe driving detection. Using the sensors of the ego vehicle, specific characteristics of the unsafe driving behavior may be inferred, which characteristics include a type of unsafe driving behavior (e.g., aggressive, distracted, reckless), repetition degree (e.g., how frequently unsafe driving shows up), a movement pattern (e.g., periodic and non-periodic actions), a temporal context of the unsafe driving behavior (e.g., time, day, road type), and a number of lanes affected. Based on this analysis, the system classifies the unsafe driving behavior. The system also determines a profile of the driver of the ego vehicle and uses this profile, in addition to the characteristics of the unsafe driving behavior and information of the surroundings, to run a digital twin simulation to predict the possible outcomes of guidance. For example, the simulations identify whether the ego vehicle driver, based on their particular driving style (e.g., timid, aggressive), can perform a particular maneuver considering the unsafe driving behavior of a nearby vehicle. The digital twin simulations analyze unsafe driving conditions and perform a “happens-before” relationship analysis with the actions of the ego vehicle. The system also considers surrogate measures of safety in recommending action to the ego vehicle.

As a specific example, responsive to aggressive driving behavior, the system may recommend that the ego vehicle driver not change lanes but stay in a current lane to avoid a collision. In a second example, responsive to distracted driving behavior, the system may recommend that the ego vehicle driver change lanes to avoid an accident.

In this way, the disclosed systems, methods, and other embodiments improve vehicle guidance by considering specific classifications of unsafe driving behaviors and the ego vehicle driver's ability to execute collision avoidance maneuvers. That is, the disclosed systems, methods, and other embodiments provide guidance based not only on detected unsafe driving behaviors but also on specific features/characteristics of the unsafe driving behaviors and the ego vehicle driver's driving capability. As such, the systems, methods, and other embodiments disclosed herein provide a more accurate representation of the environment/circumstances surrounding the ego vehicle and the behavior of the ego vehicle and adjacent vehicles. Doing so 1) improves the reliability of the vehicle guidance, whether the vehicle guidance is navigation instructions or autonomous controls of a vehicle, and 2) promotes a safer operation of the vehicle. The present system improves vehicle guidance by reducing the likelihood that the provided guidance, intended to reduce the risk of collision, creates a dangerous situation for the ego vehicle and its passenger.

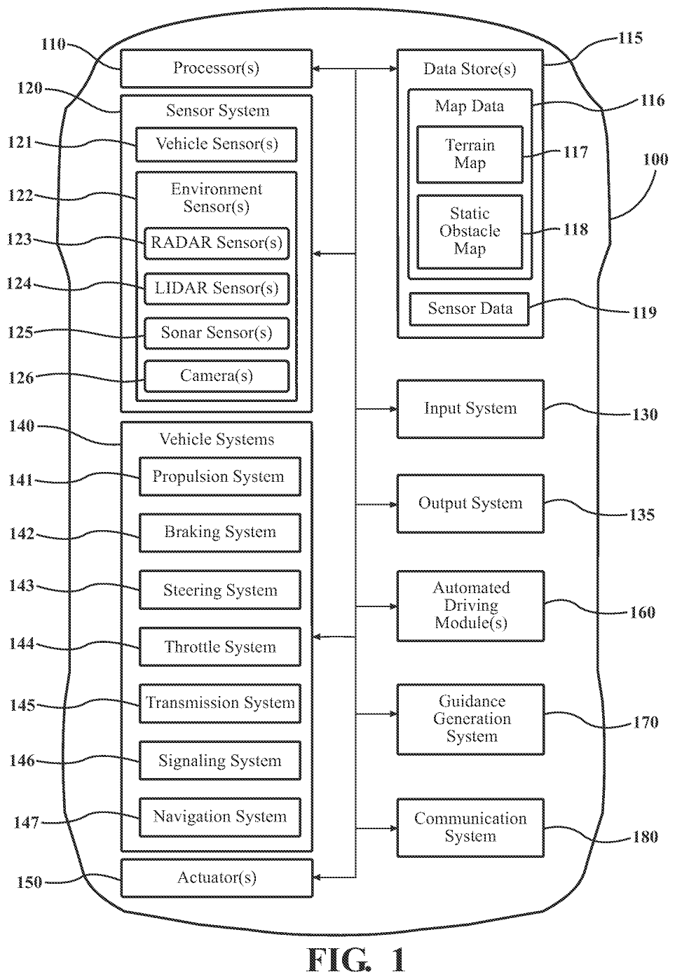

Referring to FIG. 1, an example of a vehicle 100 is illustrated. As used herein, a “vehicle” is any form of transport that may be motorized or otherwise powered. In one or more implementations, the vehicle 100 is an automobile. While arrangements will be described herein with respect to automobiles, it will be understood that embodiments are not limited to automobiles. In some implementations, the vehicle 100 may be a robotic device or a form of transport that, for example, includes sensors to perceive aspects of the surrounding environment, and thus benefits from the functionality discussed herein associated with providing vehicle anti-collision guidance/control that is specific to an identified class of unsafe driving behavior and an ego vehicle driver profile.

The vehicle 100 also includes various elements. It will be understood that in various embodiments it may not be necessary for the vehicle 100 to have all of the elements shown in FIG. 1. The vehicle 100 can have different combinations of the various elements shown in FIG. 1. Further, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Further, the elements shown may be physically separated by large distances. For example, as discussed, one or more components of the disclosed system can be implemented within a vehicle while further components of the system are implemented within a cloud-computing environment or other system that is remote from the vehicle 100.

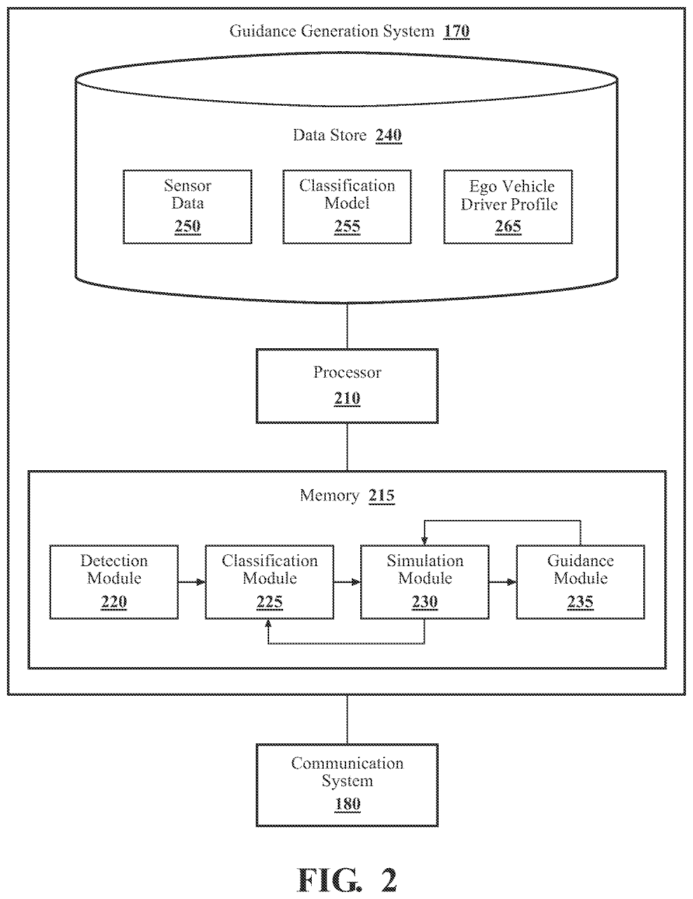

Some of the possible elements of the vehicle 100 are shown in FIG. 1 and will be described along with subsequent figures. However, a description of many of the elements in FIG. 1 will be provided after the discussion of FIGS. 2-7C for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the vehicle 100 includes a guidance generation system 170 that is implemented to perform methods and other functions as disclosed herein relating to improving anti-collision vehicle guidance/control by basing such on classes of unsafe driving behavior and an ego vehicle driver profile.

As will be discussed in greater detail subsequently, the guidance generation system 170, in various embodiments, is implemented partially within the vehicle 100, and as a cloud-based service. For example, in one approach, functionality associated with at least one module of the guidance generation system 170 is implemented within the vehicle 100 while further functionality is implemented within a cloud-based computing system. Thus, the guidance generation system 170 may include a local instance at the vehicle 100 and a remote instance that functions within the cloud-based environment.

In an example, the guidance generation system 170, may be implemented partially within the vehicle 100, as a cloud-based service, and in other vehicles. For example, in one approach, functionality associated with at least one module of the guidance generation system 170 is implemented within the vehicle 100, while further functionality is implemented within a cloud-based computing system and/or a network of connected vehicles. Thus, the guidance generation system 170 may include a local instance at the vehicle 100, a remote instance that functions within the cloud-based environment and/or a network of connected vehicles. As such, some vehicles can form a peer-to-peer group over a vehicular network and provide the functionality described herein.

Moreover, the guidance generation system 170, as provided for within the vehicle 100, functions in cooperation with a communication system 180. In one embodiment, the communication system 180 communicates according to one or more communication standards. For example, the communication system 180 can include multiple different antennas/transceivers and/or other hardware elements for communicating at different frequencies and according to respective protocols. The communication system 180, in one arrangement, communicates via a communication protocol, such as a WiFi, DSRC, V2I, V2V, or another suitable protocol for communicating between the vehicle 100 and other entities in the cloud environment. Moreover, the communication system 180, in one arrangement, further communicates according to a protocol, such as global system for mobile communication (GSM), Enhanced Data Rates for GSM Evolution (EDGE), Long-Term Evolution (LTE), 5G, or another communication technology that provides for the vehicle 100 communicating with various remote devices (e.g., a cloud-based server). In any case, the guidance generation system 170 can leverage various wireless communication technologies to provide communications to other entities, such as members of the cloud-computing environment.

With reference to FIG. 2, one embodiment of the guidance generation system 170 is further illustrated. As described above, in one embodiment the guidance generation system 170 is on the vehicle 100 depicted in FIG. 1. In another example, the guidance generation system 170 is on a remote server. In either case, the guidance generation system 170 includes a processor 210. The processor 210 may be a part of the guidance generation system 170, the guidance generation system 170 may include a separate processor from the processor 110 of the vehicle, or the guidance generation system 170 may access the processor 210 through a data bus or another communication path. In one embodiment, the guidance generation system 170 includes a memory 215 that stores a detection module 220, a classification module 225, a simulation module 230, and a guidance module 230. The memory 215 is a random-access memory (RAM), read-only memory (ROM), a hard-disk drive, a flash memory, or another suitable memory for storing the modules 220, 225, 230, and 235. The modules 220, 225, 230, and 235 are, for example, computer-readable instructions that, when executed by the processor 210, cause the processor 210 to perform the various functions disclosed herein. In alternative arrangements, the modules 220, 225, 230, and 235 are independent elements from the memory 215 that are, for example, comprised of hardware elements. Thus, the modules 220, 225, 230, and 235 are alternatively ASICs, hardware-based controllers, a composition of logic gates, or another hardware-based solution.

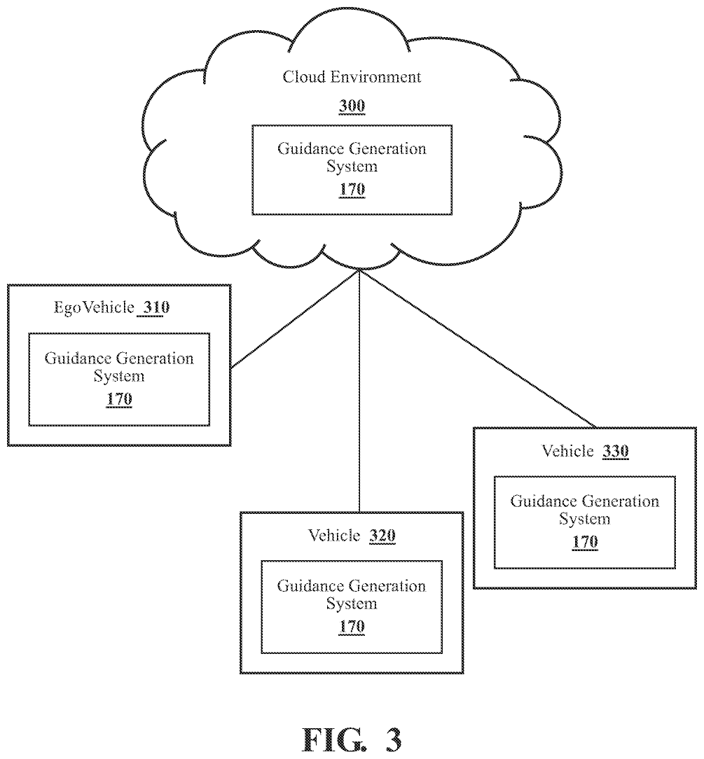

FIG. 3 illustrates one example of a cloud-computing environment 300 that may be implemented along with the guidance generation system 170. As illustrated in FIG. 3, the guidance generation system 170 may be embodied at least in part within the cloud-computing environment 300.

In one or more approaches, the cloud environment 300 may facilitate communications between multiple different vehicles to acquire and distribute information between vehicles 310, 320, and 330, each of which may be an example of the vehicle 100 depicted in FIG. 1. That is, as described above, it may be that functionality associated with the modules of the guidance generation system 170 is implemented within the ego vehicle 310 while further functionality of the modules is implemented within a remote server in the cloud environment 300 and/or other vehicles 320 and 320 that are connected in a peer-to-peer network.

The ego vehicle 310 may have limited processing capability. Implementing instances of the guidance generation system 170 on a cloud-based computing system in a cloud environment 300 and/or peer-to-peer connected vehicles 320 and 330 may increase the detection, classification, simulation, and guidance generation capabilities. As one particular example, a simulation module 230 in a cloud environment 300 may rely on sensor data from multiple vehicles 310, 320, and 330 to classify an unsafe driving behavior of a vehicle in the vicinity of the network of vehicles and simulate the candidate anti-collision guidance. In another example, the functionality of the simulation module 230 may be distributed across multiple additional vehicles 320 and 330 in the peer-to-peer network. Doing so increases the processing bandwidth of the system and may provide a more accurate assessment of the environment such that environment-specific guidance may be provided more quickly to the ego vehicle 310. While particular reference is made to a particular assignation of functionalities, other combinations and distributions of functionalities may be assigned to different entities within the cloud environment.

Accordingly, as shown, the guidance generation system 170 may include separate instances within one or more entities of the cloud-based environment 300, such as servers, and also instances within vehicles that function cooperatively to acquire, analyze, and distribute the noted information. In a further aspect, the entities that implement the guidance generation system 170 within the cloud-based environment 300 may vary beyond transportation-related devices and encompass mobile devices (e.g., smartphones), and other devices that may be carried by an individual within a vehicle, and thereby can function in cooperation with the vehicle 100. Thus, the set of entities that function in coordination with the cloud environment 300 may be varied.

The cloud-based environment 300 itself, as previously noted, is a dynamic environment that comprises cloud members that are routinely migrating into and out of a geographic area. In general, the geographic area, as discussed herein, is associated with a broad area, such as a city and surrounding suburbs. In any case, the area associated with the cloud environment 300 can vary according to a particular implementation but generally extends across a wide geographic area.

Returning to FIG. 2, in one embodiment, the guidance generation system 170 includes a data store 240. The data store 240 is, in one embodiment, an electronic data structure stored in the memory 215 or another data storage device and that is configured with routines that can be executed by the processor 210 for analyzing stored data, providing stored data, organizing stored data, and so on. Thus, in one embodiment, the data store 240 stores data used by the modules 220, 225, 230, and 235 in executing various functions. In one embodiment, the data store 240 stores the sensor data 250 along with, for example, metadata that characterizes various aspects of the sensor data 250. For example, the metadata can include location coordinates (e.g., longitude and latitude), relative map coordinates or tile identifiers, time/date stamps from when the separate sensor data 250 was generated, and so on.

In one embodiment, the sensor data 250 includes data collected by the vehicle sensor system(s) 120 of an ego vehicle and in some examples, data collected by the vehicle sensor system(s) of additional vehicles in the vicinity of the ego vehicle 310. The sensor data 250 may include observations of a surrounding environment of the vehicles and/or information about the vehicles themselves. The sensor system 120 can include one or more sensors to collect this information. In various configurations, the sensor system 120 includes one or more environment sensors 122 and/or one or more vehicle sensors 121. Various examples of different types of sensors will be described herein. However, it will be understood that the embodiments are not limited to the particular sensors described.

The environment sensors 122 sense a surrounding environment (e.g., external) of the vehicle 100 and/or, in at least one arrangement, an environment of a passenger cabin of the vehicle 100. For example, the one or more environment sensors 122 sense objects in the surrounding environment of the vehicle 100. Such obstacles may be stationary objects and/or dynamic objects. As an example, in one or more arrangements, the environment sensors 122 include one or more radar sensors 123, one or more LIDAR sensors 124, one or more sonar sensors 125 (e.g., ultrasonic sensors), and/or one or more cameras 126 (e.g., monocular, stereoscopic, RGB, infrared, etc.).

The environment sensor 122 output is used by the detection module 220 to detect adjacent vehicles exhibiting unsafe driving behavior that are to be avoided. As such, the sensor data 250 includes at least camera images of the surrounding environment, including the vehicles within the environment. In further arrangements, the sensor data 250 includes output from a radar sensor 123, a LidAR sensor 124, and other sensors as may be suitable for identifying vehicles in the vicinity of the ego vehicle.

In an example, the data store 240 includes sensor data 250 for multiple vehicles. As described above, the guidance generation system 170 may rely on sensor data from multiple vehicles to identify an unsafely driven vehicle. That is, in one example, the detection and classification of unsafe driving behavior are based on sensor data 250 collected from just the ego vehicle 310. In another example, the detection and classification of an unsafe driving behavior are based on sensor data 250 collected from the ego vehicle 310 and other vehicles 320 and 330 in the vicinity. In this example, the guidance generation system 170 acquires the sensor data 250 from the additional vehicles 320 and 330 via respective communication systems 180.

The sensor data 250 also includes data from the vehicle sensor(s) 121, which function to sense information about the vehicles themselves. As described above, the vehicle guidance that is ultimately provided to the ego vehicle 310 is based on the ego vehicle driver profile 265, which ego vehicle driver profile 265 includes the driving characteristics of the ego vehicle driver. The ego vehicle driver profile 265 may be generated based on data collected from the vehicle sensor(s) 121. As an example, the vehicle sensor(s) 121 may include sensors that monitor the operation of different vehicle systems such as the propulsion system 141, the braking system 142, the steering system 143, the throttling system 144, the transmission system 145, and the signaling system 146 among others. The ego vehicle driver profile 265 is based on the output of these and other vehicle sensor(s) 121, which indicate the driving traits of the ego vehicle driver. In addition to those sensors mentioned above, the vehicle sensor(s) 121 may include one or more accelerometers, one or more gyroscopes, one or more component sensors, an inertial measurement unit (IMU), a dead-reckoning system, a global navigation satellite system (GNSS), a global positioning system (GPS), and/or other sensors for monitoring aspects and vehicle systems 140 of the vehicle 100.

In one embodiment, the data store 240 further includes a classification model 255 which facilitates the classification of a detected unsafe driving behavior. That is, as described above, there may be different classes of unsafe driving behavior. Rather than basing driver assistance on a general “unsafe” category of driving behavior, the present guidance generation system 170 generates class-specific driver assistance. The classification model 255 includes the weights, variables, algorithms, etc., or other data that allow the classification module 225 to differentiate between the different types of unsafe driving behaviors and classify a detected unsafe driving behavior based on any number of criteria.

In one embodiment, the data store 240 further includes an ego vehicle driver profile 265 which characterizes the tendencies, capabilities, and/or patterns of the ego vehicle driver. That is, different types of drivers may exhibit different behaviors. For example, an inexperienced driver may change lanes more slowly, signal for a longer period before changing lanes, drive at generally slower speeds, and have slower reaction times. By comparison, an experienced driver may change lanes more quickly, signal for a shorter period before changing lanes, drive at generally higher speeds, and have quicker reaction times. The ego vehicle driver profile 265 includes all of this information, and other information, for an ego vehicle driver such that the simulation module 230 may be aware of the capabilities, tendencies, and/or patterns of the ego vehicle driver when determining an appropriate vehicle guidance to provide to the ego vehicle driver.

The ego vehicle driver profile 265 may be based on various data. As described above, the ego vehicle driver profile 265 may be based on ego vehicle sensor output collected from the vehicle sensor(s) 121 that determine the state and/or usage of various vehicle systems 140. In another example, the ego vehicle driver profile 265 may be based on manually input ego vehicle driver information. For example, via a user interface on the ego vehicle or a device connected to the ego vehicle, a user may enter certain user information, such as age, vision characteristics, years of experience driving a vehicle, etc. From this information, the guidance generation system 170 may identify certain expected capabilities, tendencies, or patterns for a driver with these user traits.

While particular reference is made to generating an ego vehicle driver profile 265 based on certain information, other information may be used to generate an ego vehicle driver profile 265. In these and other examples, the ego vehicle driver profile 265 may be supplemented by additional information. For example, the guidance generation system 170 may identify other drivers having similar user information as the ego vehicle driver or similar detected driving patterns for a specific road section. Profiles may be associated with these similar drivers. In this example, based on the user information/driving pattern similarities of the ego vehicle driver and the other driver, the guidance generation system 170 may expect the ego vehicle driver to have similar capabilities, tendencies, and patterns as the other driver on this particular road section and generate a profile indicative of such. As such, the ego vehicle driver profile may be based on a profile of a similar driver. In some examples the profile may be specific to a particular road section.

The guidance generation system 170 further includes a detection module 220 that, in one embodiment, includes instructions that cause the processor 210 to detect an unsafe driving behavior of a vehicle in the vicinity of an ego vehicle 310. Certain vehicle behaviors, such as maintaining a safe distance from other vehicles, signaling before/during lane changes, remaining in lanes, and adhering to posted speed limits, are deemed safe as they do not pose a serious risk to adjacent vehicles. By comparison, other behaviors of a vehicle, such as weaving across multiple lanes of traffic, driving faster than posted speed limits, and failing to indicate turns and lane changes with a signal, are indicative that a driver is engaging in behavior that may endanger other vehicles and/or pedestrians on a roadway. Other examples of characteristics indicative of unsafe/safe driving include but are not limited to the timing of driving maneuvers such as changing lanes, a rate of acceleration, deceleration, turning, and lane change frequency. While particular reference is made to a few characteristics that indicate unsafe/safe driving, the detection module 220 may rely on any number of these or other characteristics in detecting unsafe driving in the vicinity of the ego vehicle 310.

The detection module 220 analyzes the sensor data 250, from the ego vehicle 310 and/or additional vehicles to determine whether a vehicle is exhibiting unsafe or safe driving behavior. As such, the detection module 220 generally includes instructions that function to control the processor 210 to receive data inputs from one or more sensors of the vehicle. In one embodiment, the inputs are observations of one or more objects in an environment proximate to the vehicle and/or other aspects about the surroundings. As provided for herein, the detection module 220, in one embodiment, acquires sensor data 250 that includes at least camera images. In further arrangements, the detection module 220 acquires the sensor data 250 from further sensors such as a radar sensor 123, a LiDAR sensor 124, and other sensors as may be suitable for identifying vehicles and locations of the vehicles.

Accordingly, in one embodiment, the detection module 220 controls the respective sensors to provide the data inputs in the form of the sensor data 250. Additionally, while the detection module 220 is discussed as controlling the various sensors to provide the sensor data 250, in one or more embodiments, the detection module 220 can employ other techniques to acquire the sensor data 250 that are either active or passive. For example, the detection module 220 may passively sniff the sensor data 250 from a stream of electronic information provided by the various sensors to further components within the vehicle. Moreover, the detection module 220 can undertake various approaches to fuse data from multiple sensors when providing the sensor data 250 and/or from sensor data acquired over a wireless communication link (e.g., v2v) from one or more of the surrounding vehicles. Thus, the sensor data 250, in one embodiment, represents a combination of perceptions acquired from multiple sensors.

The detection module 220, in one embodiment, controls the sensors to acquire the sensor data 250 about an area that encompasses 360 degrees about the vehicle 100 in order to provide a comprehensive assessment of the surrounding environment. Of course, in alternative embodiments, the detection module 220 may acquire the sensor data in a single direction (i.e., a backward direction).

From this sensor data 250, the detection module 220 detects unsafe driving behavior, i.e., driving behavior that is reckless, distracted, or aggressive. Such a determination may be made based on identified driving characteristics. That is, the detection module 220 identifies certain driving characteristics and, based on such, determines whether the vehicle exhibits unsafe or safe driving behaviors.

In an example, the detection system 220 may perform a time-series analysis to detect and identify the driving maneuvers over time. For example, if a certain number of maneuvers indicative of unsafe driving occurs in a threshold period, the detection module 220 may tag the subject vehicle (i.e., the rear vehicle) as unsafe. As such, the detection module 220 detects unsafe driving behavior based on a sensor system of the ego vehicle.

In another example, a remote server may run anomaly detection with data from multiple vehicles. In this example, the remote server or remote servers may consider sensor data 250 from multiple vehicles and perform a time-series analysis to detect an anomalous driving behavior, which driving behavior may be tagged as an unsafe driving behavior. In this example, the remote server requests sensor data 250 from other vehicles in the vicinity of the unsafe vehicle. Based on an aggregated consideration of the sensor data 250 from the multiple vehicles may identify an unsafe driving behavior. In this example, the detection module 220 detects the unsafe driving behavior based on sensor systems of multiple vehicles 320 and 330 in the vicinity of the vehicle and the ego vehicle 310.

In one approach, the detection module 220 implements and/or otherwise uses a machine learning algorithm. In one configuration, the machine learning algorithm is embedded within the detection module 220 such as a convolutional neural network (CNN), to perform unsafe driving behavior detection based on the sensor data 250. Of course, in further aspects, the detection module 220 may employ different machine learning algorithms or implement different approaches for performing unsafe driving behavior detection. Whichever particular approach the detection module 220 implements, the detection module 220 provides an output of an indication of detected unsafe driving behavior. In this way, the detection module 220 provides a general indication of a driver on a roadway that the ego vehicle 310 may want to avoid to ensure safety. In any case, the output of the detection module 220 is transmitted to the classification module 225 to classify a detected unsafe driving behavior.

The guidance generation system 170 further includes a classification module 220 that, in one embodiment, includes instructions that cause the processor 210 to classify unsafe driving behavior based on its characteristics. As described above, unsafe driving behavior is a general category of a type of driving and encompasses various behaviors. If vehicle guidance is provided on the more general indication that a behavior is unsafe, the guidance may lead to other potentially dangerous situations described above. As such, the classification module 225 further characterizes the unsafe driving behavior such that the simulations and generated guidance are more targeted for the class of unsafe driving behavior. Thus, more targeted, customized, and reliable driver assistance is provided based on more than a general designation of unsafe driving behavior but specifically tailored to a particular classification of unsafe driving behavior. In general, the classification module 225 identifies patterns in the behavior of different drivers such that future behavior may be predicted and simulated.

The unsafe driving behavior may be classified based on any number of criteria. For example, the unsafe driving behavior may be classified based on a type of the unsafe driving behavior. As described above, an aggressive driver may closely follow a vehicle or cut in between vehicles, a distracted driver may swerve within a lane and exhibit delayed reaction times, and a reckless driver may run red lights and change lanes without signaling. Based on the collected sensor data 250 indicating the movement and position of vehicles, the classification module 225 may classify the detected unsafe driving behavior based on a determined type of unsafe driving behavior. As such, the classification module 225 includes a database, machine-learning algorithm, or other instruction that associates certain driving behaviors with particular behavior types.

In another example, the unsafe driving behavior may be classified based on a degree of repetition of the unsafe driving behavior, that is, how frequently the unsafe driving behavior occurs. Other examples of characteristics upon which a classification of the unsafe driving behavior is based include but are not limited to 1) a movement pattern of the unsafe driving behavior (e.g., sharp, quick lane changes, s-shaped swerves, etc.), 2) a periodicity of the actions, 3) a temporal context of the unsafe driving behavior, that is the time of day as well as the day of the week and/or year, and 4) the number of lanes affected. As a particular example, the classification module 225 may classify the unsafe driving behavior of a neighboring vehicle as aggressive, exhibiting a weaving movement between lanes in sharp, quick maneuvers (i.e., zig-zagging) occurring periodically every four seconds and affecting four lanes of traffic. As another particular example, the classification module 225 may classify the unsafe driving behavior of a neighboring vehicle as being distracted, exhibiting an s-shaped weaving movement within a single lane of traffic. While particular reference is made to particular characteristics upon which a classification of unsafe driving behavior is based, such a classification may be based on any other criteria. For example, sensor data 250 may indicate that a following vehicle is repeatedly drawing closer and farther away from the ego vehicle 310, i.e., exhibiting a nudging behavior. This may indicate that the following vehicle is attempting to overtake the ego vehicle 310 and is exhibiting aggressive behavior towards the ego vehicle 310.

In any case, the classification module 225 receives sensor data 250 associated with a vehicle that has been identified as being unsafe and further analyzes the sensor data 250 to classify the behavior to facilitate more targeted vehicle guidance. In this example, the classification module 225 operates on data filtered by the detection module 220. That is, the classification module 225 receives an indication of a vehicle that has been tagged as unsafe and more extensively analyzes the sensor data 250 associated with the unsafe vehicle to classify the unsafe driving behavior. Doing so reduces the load on the classification module 225. That is, rather than analyzing all sensor data 250 to identify classification traits, the classification module 225 performs the more extensive analysis on just that sensor data 250 that is associated with unsafe driving behavior. Accordingly, in one embodiment, the classification module 225 controls the respective sensors to provide the data inputs in the form of the sensor data 250. That is, the classification module 225 includes instructions that, when executed by the processor, cause the processor to determine from the sensor data 250, a class of unsafe driving behavior based on identified patterns of movement.

In one approach, the classification module 225 implements and/or otherwise uses a machine learning algorithm. In one configuration, the machine learning algorithm is embedded within the classification module 225 such as a convolutional neural network (CNN), to perform unsafe driving behavior classification based on the sensor data 250. Of course, in further aspects, the classification module 225 may employ different machine learning algorithms or implement different approaches for performing unsafe driving behavior classification. Whichever particular approach the classification module 225 implements, the classification module 225 provides an output of unsafe driving behavior classification. In this way, the classification module 225 provides a more technically accurate representation of the neighboring vehicle's behavior such that a targeted guidance may be suggested.

It should be appreciated that the classification module 225, in combination with the classification model 255, can form a computational model such as a neural network model. In any case, the classification module 225, when implemented with a neural network model or another model in one embodiment, implements functional aspects of the classification model 255 while further aspects, such as learned weights, may be stored within the data store 240. Accordingly, the classification model 255 is generally integrated with the classification module 225 as a cohesive functional structure. In any case, the output of the classification module 225 is transmitted to the simulation module 230 for simulating various candidate ego vehicle responses.

The guidance generation system 170 further includes a simulation module 230 that, in one embodiment, includes instructions that cause the processor 210 to simulate candidate ego vehicle responses to the unsafe driving behavior based on 1) a classification of the unsafe driving behavior and 2) a profile of an ego vehicle driver. As described above, it may be the case that a default guidance suggestion would put the ego vehicle 310 and any passengers in danger. As such, the simulation module 230 simulates multiple potential options to ensure the safety of the guidance that is ultimately provided.

As described above, the simulation is based on a classification of unsafe driving behavior and the ego vehicle driver profile 265. As such, the simulation module 230 includes instructions to acquire the ego vehicle driver profile 265 from the data store 240 and the classification of the unsafe driving behavior from the classification module 225.

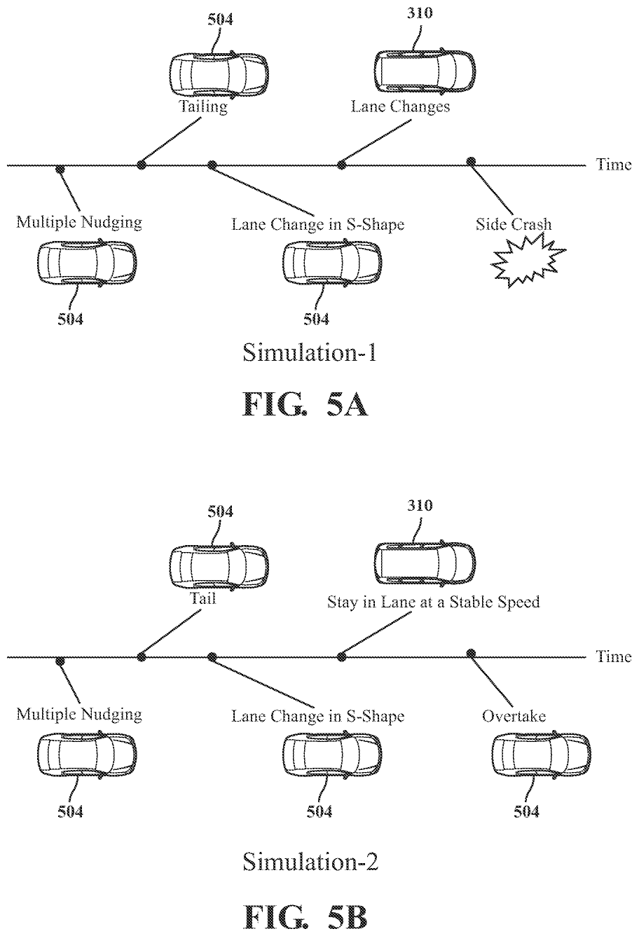

In general, the simulation module 230 predicts the actions of the unsafe driver based on the classification of the unsafe driving behavior. This prediction may be based on the classification of the unsafe driving behavior and observed vehicle maneuvers. In an example, the simulation module 230 executes a simulation based on a “happens-before” relationship of observed maneuvers of the neighboring vehicle. That is, the simulation module 230 includes instructions that, when executed by the processor 210, cause the processor 210 to predict an action of the vehicle based on a time-ordered sequence of detected maneuvers and the classification of the unsafe driving behavior. For example, an unsafe driver may exhibit a pattern, executing maneuver A, then maneuver B, and then maneuver C. As such, when maneuvers A and B are detected, the simulation module 230 predicts that the vehicle will likely execute maneuver C next. FIG. 5 below depicts an example where a driver, identified as aggressive, performs multiple nudging actions, followed by tailing the ego vehicle. In this example, the simulation module 230 may predict that the following action by the neighboring vehicle is a lane change in an s-shape pattern. This prediction that the vehicle will perform an s-shape lane change may govern the provided guidance.

In some examples, the prediction of the neighboring vehicle's action may be modified by the characteristics of the neighboring vehicle and/or the surrounding environment of the vehicle and the ego vehicle 310. For example, continuing the above example, the sensor data 250 may indicate that the neighboring vehicle is towing a trailer. As such, the simulation module 230 may alter the predicted following action of the neighboring vehicle (previously identified as aggressive) as likely not including an s-shaped lane change, as the configuration of the neighboring vehicle (e.g., towing a trailer) would not facilitate such movement.

As another example, the simulation module 230 may alter the prediction and base the simulation on the surrounding environment of the vehicle and the ego vehicle 310. For example, vehicle sensors, or any number of other sensors, may indicate foggy weather or precipitation. In this example, the expected behavior of a neighboring vehicle and the ego vehicle 310 may be altered based on the current weather conditions. For example, an expected action may be tempered in severity based on precipitation. As such, the simulation module 230 may simulate actions of the neighboring vehicle that are doable based on the characteristics of the vehicle and the surrounding environment of the vehicle and the ego vehicle 310.

The simulations may also be based on the ego vehicle driver profile 265. As with the neighboring vehicle, an ego vehicle driver exhibits certain driving tendencies, which may be considered when simulating different candidate ego vehicle responses. For example, an inexperienced driver may have slower reaction times and may be more hesitant to execute a suggested driving maneuver than an experienced driver. As a specific example, given an aggressive driver with an s-shape weaving pattern occurring every 3 seconds and affecting two lanes of traffic, an inexperienced driver may be instructed to remain in their lane to avoid an impending collision. By comparison, if the ego vehicle driver is an experienced driver who can quickly make a lane change, under these same circumstances, the guidance may instruct the experienced driver to make the lane change. In either case, the simulation module 230 simulates different scenarios based on the ego vehicle driver profile 265 to determine the safest or desired guidance strategy based on the ego driver's tendencies, patterns, and capabilities. Thus, the guidance is based on the ego vehicle driver profile 265, where a recommendation to change lanes is provided to an experienced driver based on the experienced driver's ability to make a lane change quickly. As such, the simulation module 230 may simulate different scenarios based on what is doable by the ego vehicle driver, as indicated in the ego vehicle driver profile 265.

In an example, the simulation module 230 simulation is further based on surrogate measures of safety. Surrogate measures of safety are indirect indicia of an upcoming collision. There are many surrogate measures of safety. Examples include a deceleration rate to avoid a crash (DRAC) metric, which identifies the rate at which a vehicle needs to decrease to avoid a crash. Another example is a stopping distance (SD) metric, which identifies the distance remaining to a projected location of a crash. Another example is a time gap (TG) metric, which identifies the time between the moment of the rear-end of the first vehicle passes a certain point on the road and the front of the following vehicle arriving at that point. Another example is the time to collision (TTC) metric, which identifies the time to a collision if the speed of each vehicle remains constant. Another example is a potential indicator of collision with urgent deceleration (PICUD) metric, which identifies a likelihood of a collision between vehicles when the leading vehicle engages its emergency brake.

The guidance generation system 170 may account for any of these or other surrogate measures of safety when generating the guidance. For example, it may be that instructing an ego vehicle 310 to change lanes would place the ego vehicle 310 close enough behind a lead vehicle that the ego vehicle driver would not be able to avoid a collision were the leading vehicle to engage its emergency brake, as measured by the PICUD surrogate safety measure. As such, the simulation to change lanes may indicate and negatively weigh this option as a candidate ego vehicle response. Note that in this example, the simulation module 230 may still account for the ego vehicle driver's tendencies, capabilities, and patterns. For example, the PICUD may differ based on a particular driver's profile, with a more experienced driver being able to stop more quickly to respond to a lead vehicle application of an emergency brake than an inexperienced driver.

Furthermore, the simulations may be based on the historical behavior of other drivers in similar situations and resulting outcomes. In this example, the simulation module 230 may be trained on a database of collected data regarding simulations and outcomes that resulted from the execution of selected guidance. This data may be fed to the simulation module 230 to train the simulation module 230 in evaluating different situations.

In an example, the simulation executed by the simulation module 230 may be a digital twin simulation of the candidate ego vehicle 310 responses to the unsafe driving behavior. In an example, the digital twin simulation is a virtual representation of the environment, updated from real-time data, and using simulation, machine learning, and reasoning to help decision-making. A guidance generating system 170 on a remote server may execute the digital twin simulation. That is, an ego vehicle 310 may have limited processing resources, rendering any simulation performed thereon limited. As such, a remote server may execute a digital twin simulation, thus providing more details and greater processing capability.

In one approach, the simulation module 230 implements and/or otherwise uses a machine learning algorithm. In one configuration, the machine learning algorithm is embedded within the simulation module 230 such as a convolutional neural network (CNN), to perform response simulation based on the sensor data 250. Of course, in further aspects, the simulation module 230 may employ different machine learning algorithms or implement different approaches for performing response simulation. Whichever particular approach the simulation module 230 implements, the simulation module 230 provides an output of simulation runs.

In any case, the output of the simulation module 230 may be transmitted to the classification module 225 for modification of the classification operations performed therein. That is, the classification module 225 may be a machine learning module that is continually trained on real-time data. As such, the classification module 225 may include instructions that, when executed by the processor 210, cause the processor to classify the unsafe driving behavior based on previously executed simulations.

The guidance generation system 170 further includes a guidance module 235 that, in one embodiment, includes instructions that cause the processor 210 to generate guidance for the ego vehicle 310 based on a selected vehicle response. That is, the simulation deemed the safest, based on evaluating metrics, may be provided to the guidance module 235, and transmitted to the ego vehicle via a communication system. That is, the overall safety of the simulations may be scored based on compliance with surrogate measures of safety, the likelihood of a collision, or any other metric. For example, the simulations may be ranked such that those simulations with a higher ranking indicate a more safe response. In this example, the simulation with the highest rank may be transmitted to the guidance module 235, which generates the guidance for the ego vehicle.

As a particular example, a first simulation where an ego vehicle driver is instructed to change lanes may have a first safety score based on a potential likelihood of collision with a following vehicle that is aggressive. By comparison, a second simulation where the ego vehicle 310 is instructed to remain in its lane to avoid a collision with a following vehicle may be ranked higher due to the absence of a potential collision with the following vehicle.

In any example, the guidance may be of a variety of forms. For example, the guidance module 235 may transmit the guidance to an automated driving system or a navigation system of the ego vehicle 310. In a first example, the automated driving system may control the vehicle at the time of the detected unsafe driving behavior or take control of the vehicle in response to the detected unsafe driving behavior. In this example, the automated driving module 160 of the vehicle may execute the guidance to avoid a potentially dangerous situation with the vehicle exhibiting unsafe driving behavior. In a second example, the guidance may be used by a navigation system 147 to visually, audibly, or haptically instruct a driver on what maneuver to execute to avoid a collision. In any case, the guidance may be transmitted to the ego vehicle 310 via the respective communication systems 180.

In any case, the output of the generation module 235 may be transmitted to the simulation module 230 for modification of the simulation operations performed therein. That is, the simulation module 230 may be a machine learning module that is continually trained on real-time data. As such, the simulation module 230 may include instructions that, when executed by the processor, cause the processor to simulate candidate ego vehicle responses based on an outcome associated with previously generated guidance.

In one or more configurations, the guidance generation system 170 implements one or more machine learning algorithms. As described herein, a machine learning algorithm includes but is not limited to deep neural networks (DNN), including transformer networks, convolutional neural networks, recurrent neural networks (RNN), etc., Support Vector Machines (SVM), clustering algorithms, Hidden Markov Models, and so on. It should be appreciated that the separate forms of machine learning algorithms may have distinct applications, such as agent modeling, machine perception, and so on.

Moreover, it should be appreciated that machine learning algorithms are generally trained to perform a defined task. Thus, the training of the machine learning algorithm is understood to be distinct from the general use of the machine learning algorithm unless otherwise stated. That is, the guidance generation system 170 or another system generally trains the machine learning algorithm according to a particular training approach, which may include supervised training, self-supervised training, reinforcement learning, and so on. In contrast to training/learning of the machine learning algorithm, the guidance generation system 170 implements the machine learning algorithm to perform inference. Thus, the general use of the machine learning algorithm is described as inference.

In this way, the disclosed guidance generation system 170 improves vehicle driver assistance by taking into account specific characteristics of unsafe driving behaviors and the ego vehicle driver's ability to execute collision avoidance maneuvers. That is, the disclosed guidance generation system 170 provides guidance based not only on detected unsafe driving behavior but also on specific classifications of the unsafe driving behaviors and the ego vehicle driver's driving capability. As such, the systems, methods, and other embodiments disclosed herein provide a more accurate representation of the environment/situation surrounding the ego vehicle 310 and the behavior of the ego vehicle 310 and adjacent vehicles. Doing so 1) improves the reliability of the vehicle guidance, whether the vehicle guidance is navigation instructions or autonomous controls of a vehicle, and 2) promotes a safer operation of the vehicle. The present system improves vehicle guidance systems by reducing the likelihood that the provided guidance, intended to reduce the risk of collision, creates a dangerous situation for the ego vehicle and its passenger.

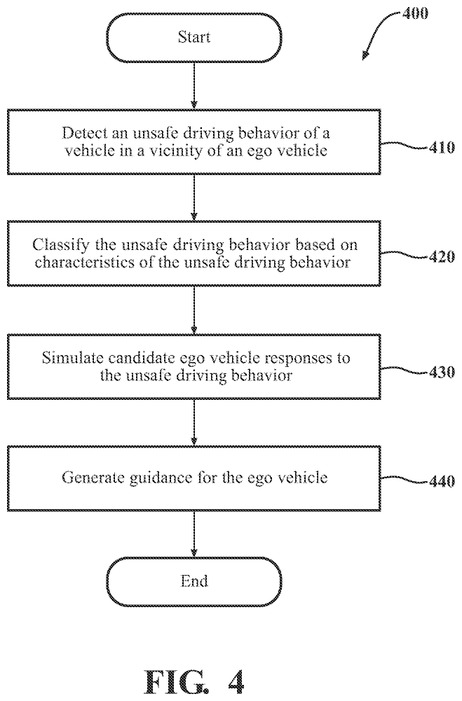

Additional aspects of improving vehicle driver assistance by basing such on a classification of an unsafe driving behavior and a profile of an ego vehicle driver will be discussed in relation to FIG. 4. FIG. 4 illustrates a flowchart of a method 400 that is associated with 1) acquiring an unsafe driving behavior classification and an ego vehicle driver profile 265 and 2) basing vehicle guidance on such. Method 400 will be discussed from the perspective of the guidance generation system 170 of FIGS. 1, and 2. While method 400 is discussed in combination with the guidance generation system 170, it should be appreciated that the method 400 is not limited to being implemented within the guidance generation system 170 but is instead one example of a system that may implement the method 400.

At 410, the detection module 220 detects an unsafe driving behavior of a vehicle in a vicinity of an ego vehicle 310. As such, the detection module 220 controls the sensor system 120 to acquire the sensor data 250. In one embodiment, the detection module 220 controls the radar sensor 123 and the camera 126 of the ego vehicle 310 to observe the surrounding environment. Alternatively, or additionally, the detection module 220 controls the camera 126 and the LiDAR 124 or another set of sensors to acquire the sensor data 250. As part of controlling the sensors to acquire the sensor data 250, it is generally understood that the sensors acquire the sensor data 250 of a region around the ego vehicle 310 with data acquired from different types of sensors generally overlapping in order to provide for a comprehensive sampling of the surrounding environment at each time step. In general, the sensor data 250 need not be of the exact same bounded region in the surrounding environment but should include a sufficient area of overlap such that distinct aspects of the area can be correlated. Thus, the detection module 220, in one embodiment, controls the sensors to acquire the sensor data 250 of the surrounding environment.

Moreover, in further embodiments, the detection module 220 controls the sensors to acquire the sensor data 250 at successive iterations or time steps. Thus, the guidance generation system 170, in one embodiment, iteratively executes the functions discussed at blocks 410-420 to acquire the sensor data 250 and provide information therefrom. Furthermore, the detection module 220, in one embodiment, executes one or more of the noted functions in parallel for separate observations in order to maintain updated perceptions. Additionally, as previously noted, the detection module 220, when acquiring data from multiple sensors, fuses the data together to form the sensor data 250 and to provide for improved determinations of detection, location, and so on.

As described above, such detection may be based on the sensor information from multiple vehicles. In this example, the detection module 220 controls the sensor systems to acquire sensor data 250 from multiple vehicles. Still further, in some cases, the guidance generation system 170 may be disposed on a remote server, in which case control includes communicating with the vehicles via respective communication systems 180 to acquire the sensor data 250.

At 420, the classification module 225 classifies the unsafe driving behavior based on characteristics of the unsafe driving behavior. That is, as described above, there are various traits of unsafe driving behavior, and the classification module 225 categorizes the behavior of a particular vehicle based on those traits. As such, the classification module 225 also controls, or communicates with, the sensor system 120 to acquire the sensor data 250. However, rather than acquiring all collected sensor data, the classification module 225 may collect just that sensor data associated with vehicles detected as exhibiting unsafe driving behavior. As such, rather than performing classification on an entire data set, the classification module 225 classifies a subset of the sensor 250.

Specifically, the classification module 225 receives an indication of a vehicle exhibiting unsafe driving behavior and analyzes the sensor data 250 associated with such to identify types of unsafe driving behavior, movement patterns, repetition patterns, and the number of lanes affected, among other traits, which are used to classify the unsafe driving behavior, such that class-specific driver assistance may be provided to the vehicle.

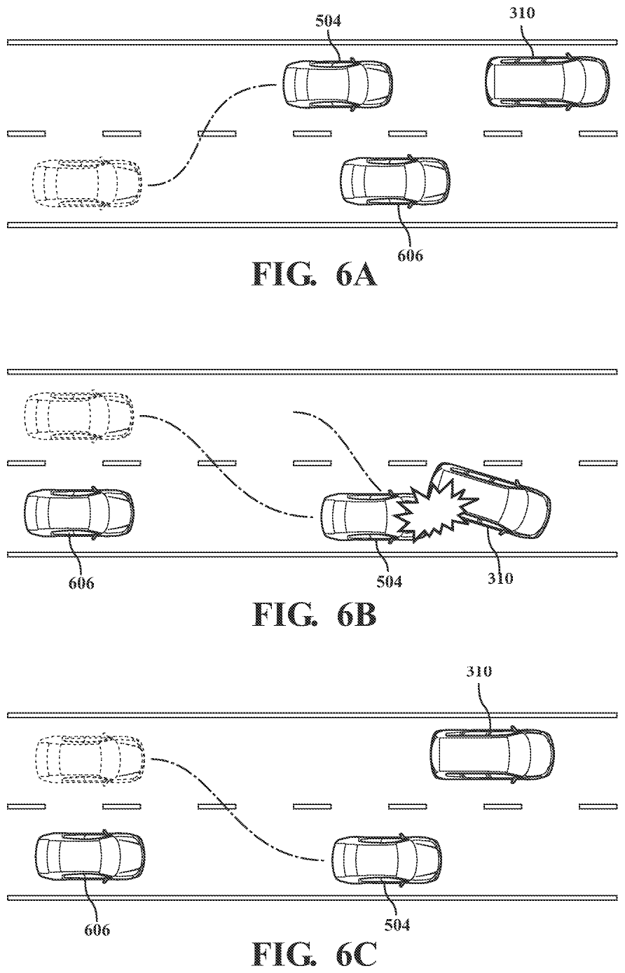

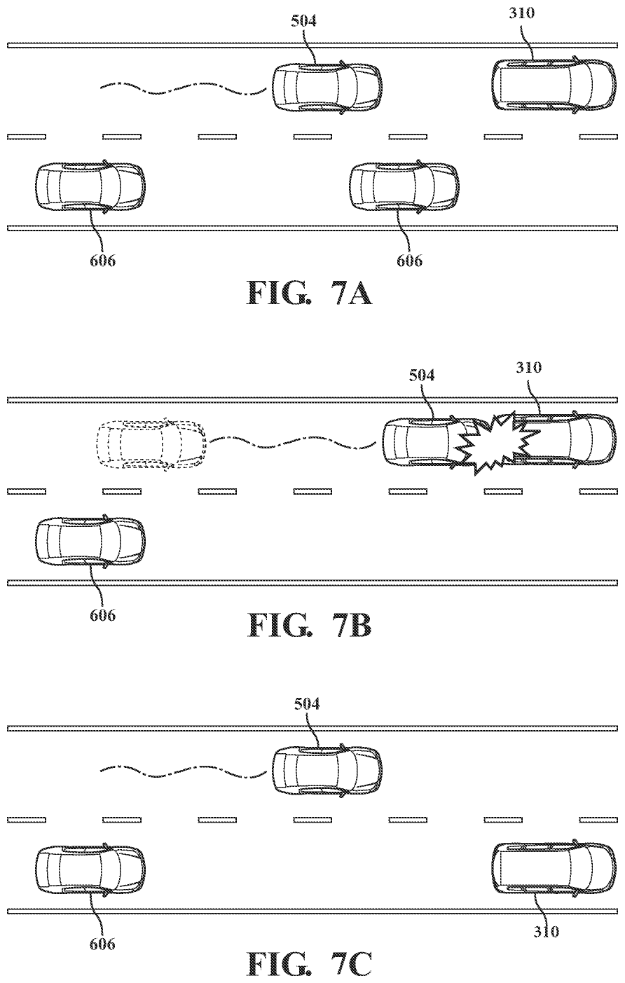

At 430, the simulation module 230 simulates candidate ego vehicle responses to the unsafe driving behavior based on 1) a classification of the unsafe driving behavior and 2) a profile of an ego vehicle driver. That is, the simulation virtually predicts the actions of the ego vehicle driver (based on the ego vehicle driver profile 265) and the other vehicle (based on the classification of the unsafe driving behavior and detected driving maneuvers). Based on these predictions, the simulation module 230 may simulate different scenarios to determine which is the safest and/or leads to a result where there is no vehicle collision. FIGS. 6A-7C below depict two cases where multiple simulations are run to identify a safe/non-collision result.

At 440, the guidance module 235 generates guidance for the ego vehicle 310 based on a selected vehicle response. That is, once a target simulation has been detected based on such being the safest of multiple simulations executed, the guidance module 235 outputs the guidance to the ego vehicle 310, for example, in the form of navigation instructions or autonomous commands to the ego vehicle 310.

FIGS. 5A and 5B illustrate digital twin simulations and possible outcomes of different suggested guidance. Specifically, FIGS. 5A and 5B depict timelines of different actions by both an ego vehicle 310 and a following vehicle 504 and the prediction of future behavior of both based on an ego vehicle driver profile 265 and a classification of unsafe driving and detected maneuvers. In this example, the simulation module 230 may receive a classification of the unsafe driving behavior of the following vehicle 504 as an input. Also in this example, the guidance generation system 170 detects a sequence of maneuvers of the following vehicle 504, specifically that the following vehicle 504 first performs multiple nudging actions followed by a tailing action. Based on these detected maneuvers, the simulation module 230 may perform a happens-before relationship analysis to determine a likely next maneuver of the following vehicle 504 to be a lane change having an s-shape profile.

In this example, various vehicle guidance suggestions may be generated. As depicted in FIG. 5A, a first simulation may have the ego vehicle 310 change lanes. However, given the driving tendencies, patterns, and/or capabilities of the ego vehicle driver as identified in the ego vehicle driver profile 265, this may result in a side collision, as indicated in FIG. 5A. By comparison, as depicted in FIG. 5B, a second simulation may have the ego vehicle 310 stay in a lane at a constant speed. Given the driving tendencies, patterns, and/or capabilities of the ego vehicle driver as identified in the ego vehicle driver profile 265, this may result in a successful overtake, avoiding risk to the ego vehicle 310 and the following vehicle 504 and its passengers. As such, the second simulation may be converted into vehicle guidance, which is passed to the ego vehicle 310.

Given that the simulations are based on the ego vehicle driver profile 265, different guidance may be selected based on different ego vehicle drivers. For example, simulations 1 and 2 depicted in FIGS. 5A and 5B may be based on a timid ego vehicle driver who does not make lane changes quickly. However, if the ego vehicle driver is an experienced driver capable of making quick and safe lane changes, simulation one may not result in an accident, in which case this may be the selected simulation on which guidance generation is based.

As described above, each simulation may consider different surrogate measures of safety and the ego vehicle driver's profile in simulating different scenarios. For example, it may be that another vehicle in front of and in the same lane as the ego vehicle 310 is slowing down. As such, in the second simulation, in which the ego vehicle 310 remains in its lane at a stable speed, the ego vehicle 310 may approach the slowing down vehicle to violate a surrogate measure of safety such as TTC (time for vehicles to collide if speed remained constant) or PICUD (likelihood of a collision between vehicles when the leading vehicle engages its emergency brake). In this example, another simulation may have the ego vehicle 310 slow down and/or pull over to the shoulder of the road to avoid a collision.

FIGS. 6A-6C illustrate an example of providing vehicle guidance based on a first classification of an unsafe driving behavior and a profile of an ego vehicle driver. As described above and as depicted in FIG. 6A, the ego vehicle 310, a remote system, or a group of vehicles (including a neighboring vehicle 606) may detect the unsafe driving behavior of a following vehicle 504. Also, as described above, the classification module 225 may classify the unsafe driving behavior. In the example depicted in FIGS. 6A-6C, the classification may indicate that the following vehicle 504 is driving aggressively, has an s-shaped weaving pattern that repeats every three seconds and affects two lanes of traffic. As depicted in FIGS. 6B and 6C, the simulation module 230 executes digital twin simulations to determine that in FIG. 6B, an instruction/command to move the ego vehicle 310 to another lane may result in a collision, while an instruction, depicted in FIG. 6C to remain in the current lane at a stable speed may avoid such a collision. As such, the stay-in-lane instruction is the safe option to reduce the risk of collision.

FIGS. 7A-C illustrate an example of providing vehicle guidance based on a second classification of an unsafe driving behavior and a profile of an ego vehicle driver. As described above and as depicted in FIG. 7A, the ego vehicle 310, a remote system, or a group of vehicles (including a neighboring vehicle 606) may detect the unsafe driving behavior of a following vehicle 504. Also, as described above, the classification module 225 may classify the unsafe driving behavior. In the example depicted in FIGS. 7A-7C, the classification may indicate that the following vehicle 504 is driving distractedly, has a zigzag-shaped weaving pattern that repeats every five seconds and affects a single lane of traffic. As depicted in FIGS. 7B and 7C, the simulation module 230 executes digital twin simulations to determine that in FIG. 7B, an instruction/command to stay in the lane may result in a collision, while an instruction depicted in FIG. 7C to change lanes may avoid such a collision. As such, the lane change instruction is the safe option to reduce the risk of collision.

FIG. 1 will now be discussed in full detail as an example environment within which the system and methods disclosed herein may operate. In some instances, the vehicle 100 is configured to switch selectively between an autonomous mode, one or more semi-autonomous modes, and/or a manual mode. “Manual mode” means that all of or a majority of the control and/or maneuvering of the vehicle is performed according to inputs received via manual human-machine interfaces (HMIs) (e.g., steering wheel, accelerator pedal, brake pedal, etc.) of the vehicle 100 as manipulated by a user (e.g., human driver). In one or more arrangements, the vehicle 100 can be a manually-controlled vehicle that is configured to operate in only the manual mode.

In one or more arrangements, the vehicle 100 implements some level of automation in order to operate autonomously or semi-autonomously. As used herein, automated control of the vehicle 100 is defined along a spectrum according to the SAE J3016 standard. The SAE J3016 standard defines six levels of automation from level zero to five. In general, as described herein, semi-autonomous mode refers to levels zero to two, while autonomous mode refers to levels three to five. Thus, the autonomous mode generally involves control and/or maneuvering of the vehicle 100 along a travel route via a computing system to control the vehicle 100 with minimal or no input from a human driver. By contrast, the semi-autonomous mode, which may also be referred to as advanced driving assistance system (ADAS), provides a portion of the control and/or maneuvering of the vehicle via a computing system along a travel route with a vehicle operator (i.e., driver) providing at least a portion of the control and/or maneuvering of the vehicle 100.

With continued reference to the various components illustrated in FIG. 1, the vehicle 100 includes one or more processors 110. In one or more arrangements, the processor(s) 110 can be a primary/centralized processor of the vehicle 100 or may be representative of many distributed processing units. For instance, the processor(s) 110 can be an electronic control unit (ECU). Alternatively, or additionally, the processors include a central processing unit (CPU), a graphics processing unit (GPU), an ASIC, an microcontroller, a system on a chip (SoC), and/or other electronic processing units that support operation of the vehicle 100.

The vehicle 100 can include one or more data stores 115 for storing one or more types of data. The data store 115 can be comprised of volatile and/or non-volatile memory. Examples of memory that may form the data store 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 115 is a component of the processor(s) 110. In general, the data store 115 is operatively connected to the processor(s) 110 for use thereby. The term “operatively connected,” as used throughout this description, can include direct or indirect connections, including connections without direct physical contact.

In one or more arrangements, the one or more data stores 115 include various data elements to support functions of the vehicle 100, such as semi-autonomous and/or autonomous functions. Thus, the data store 115 may store map data 116 and/or sensor data 119. The map data 116 includes, in at least one approach, maps of one or more geographic areas. In some instances, the map data 116 can include information about roads (e.g., lane and/or road maps), traffic control devices, road markings, structures, features, and/or landmarks in the one or more geographic areas. The map data 116 may be characterized, in at least one approach, as a high-definition (HD) map that provides information for autonomous and/or semi-autonomous functions.

In one or more arrangements, the map data 116 can include one or more terrain maps 117. The terrain map(s) 117 can include information about the ground, terrain, roads, surfaces, and/or other features of one or more geographic areas. The terrain map(s) 117 can include elevation data in the one or more geographic areas. In one or more arrangements, the map data 116 includes one or more static obstacle maps 118. The static obstacle map(s) 118 can include information about one or more static obstacles located within one or more geographic areas. A “static obstacle” is a physical object whose position and general attributes do not substantially change over a period of time. Examples of static obstacles include trees, buildings, curbs, fences, and so on.

The sensor data 119 is data provided from one or more sensors of the sensor system 120. Thus, the sensor data 119 may include observations of a surrounding environment of the vehicle 100 and/or information about the vehicle 100 itself. In some instances, one or more data stores 115 located onboard the vehicle 100 store at least a portion of the map data 116 and/or the sensor data 119. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 120 and/or the one or more sensors can be operatively connected to the processor(s) 110, the data store(s) 115, and/or another element of the vehicle 100.

Various examples of different types of sensors will be described herein. However, it will be understood that the embodiments are not limited to the particular sensors described. In various configurations, the sensor system 120 includes one or more vehicle sensors 121 and/or one or more environment sensors. The vehicle sensor(s) 121 function to sense information about the vehicle 100 itself. In one or more arrangements, the vehicle sensor(s) 121 include one or more accelerometers, one or more gyroscopes, an inertial measurement unit (IMU), a dead-reckoning system, a global navigation satellite system (GNSS), a global positioning system (GPS), and/or other sensors for monitoring aspects about the vehicle 100.

As noted, the sensor system 120 can include one or more environment sensors 122 that sense a surrounding environment (e.g., external) of the vehicle 100 and/or, in at least one arrangement, an environment of a passenger cabin of the vehicle 100. For example, the one or more environment sensors 122 sense objects the surrounding environment of the vehicle 100. Such obstacles may be stationary objects and/or dynamic objects. Various examples of sensors of the sensor system 120 will be described herein. The example sensors may be part of the one or more environment sensors 122 and/or the one or more vehicle sensors 121. However, it will be understood that the embodiments are not limited to the particular sensors described. As an example, in one or more arrangements, the sensor system 120 includes one or more radar sensors 123, one or more LIDAR sensors 124, one or more sonar sensors 125 (e.g., ultrasonic sensors), and/or one or more cameras 126 (e.g., monocular, stereoscopic, RGB, infrared, etc.).

Continuing with the discussion of elements from FIG. 1, the vehicle 100 can include an input system 130. The input system 130 generally encompasses one or more devices that enable the acquisition of information by a machine from an outside source, such as an operator. The input system 130 can receive an input from a vehicle passenger (e.g., a driver/operator and/or a passenger). Additionally, in at least one configuration, the vehicle 100 includes an output system 135. The output system 135 includes, for example, one or more devices that enable information/data to be provided to external targets (e.g., a person, a vehicle passenger, another vehicle, another electronic device, etc.).

Furthermore, the vehicle 100 includes, in various arrangements, one or more vehicle systems 140. Various examples of the one or more vehicle systems 140 are shown in FIG. 1. However, the vehicle 100 can include a different arrangement of vehicle systems. It should be appreciated that although particular vehicle systems are separately defined, each or any of the systems or portions thereof may be otherwise combined or segregated via hardware and/or software within the vehicle 100. As illustrated, the vehicle 100 includes a propulsion system 141, a braking system 142, a steering system 143, a throttle system 144, a transmission system 145, a signaling system 146, and a navigation system 147.

The navigation system 147 can include one or more devices, applications, and/or combinations thereof to determine the geographic location of the vehicle 100 and/or to determine a travel route for the vehicle 100. The navigation system 147 can include one or more mapping applications to determine a travel route for the vehicle 100 according to, for example, the map data 116. The navigation system 147 may include or at least provide connection to a global positioning system, a local positioning system or a geolocation system.

In one or more configurations, the vehicle systems 140 function cooperatively with other components of the vehicle 100. For example, the processor(s) 110, the guidance generation system 170, and/or automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the navigation and/or maneuvering of the vehicle 100. The processor(s) 110, the guidance generation system 170, and/or the automated driving module(s) 160 may control some or all of these vehicle systems 140.

For example, when operating in the autonomous mode, the processor(s) 110, the guidance generation system 170, and/or the automated driving module(s) 160 control the heading and speed of the vehicle 100. The processor(s) 110, the guidance generation system 170, and/or the automated driving module(s) 160 cause the vehicle 100 to accelerate (e.g., by increasing the supply of energy/fuel provided to a motor), decelerate (e.g., by applying brakes), and/or change direction (e.g., by steering the front two wheels). As used herein, “cause” or “causing” means to make, force, compel, direct, command, instruct, and/or enable an event or action to occur either in a direct or indirect manner.

As shown, the vehicle 100 includes one or more actuators 150 in at least one configuration. The actuators 150 are, for example, elements operable to move and/or control a mechanism, such as one or more of the vehicle systems 140 or components thereof responsive to electronic signals or other inputs from the processor(s) 110 and/or the automated driving module(s) 160. The one or more actuators 150 may include motors, pneumatic actuators, hydraulic pistons, relays, solenoids, piezoelectric actuators, and/or another form of actuator that generates the desired control.

As described previously, the vehicle 100 can include one or more modules, at least some of which are described herein. In at least one arrangement, the modules are implemented as non-transitory computer-readable instructions that, when executed by the processor 110, implement one or more of the various functions described herein. In various arrangements, one or more of the modules are a component of the processor(s) 110, or one or more of the modules are executed on and/or distributed among other processing systems to which the processor(s) 110 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an application-specific integrated circuit (ASIC), programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the vehicle 100 may include one or more automated driving modules 160. The automated driving module(s) 160, in at least one approach, receive data from the sensor system 120 and/or other systems associated with the vehicle 100. In one or more arrangements, the automated driving module(s) 160 use such data to perceive a surrounding environment of the vehicle. The automated driving module(s) 160 determine a position of the vehicle 100 in the surrounding environment and map aspects of the surrounding environment. For example, the automated driving module(s) 160 determines the location of obstacles or other environmental features including traffic signs, trees, shrubs, neighboring vehicles, pedestrians, etc.

The automated driving module(s) 160 either independently or in combination with the guidance generation system 170 can be configured to determine travel path(s), current autonomous driving maneuvers for the vehicle 100, future autonomous driving maneuvers and/or modifications to current autonomous driving maneuvers based on data acquired by the sensor system 120 and/or another source. In general, the automated driving module(s) 160 functions to, for example, implement different levels of automation, including advanced driving assistance (ADAS) functions, semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7C, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
detect an unsafe driving behavior of a vehicle in a vicinity of an ego vehicle;
classify the unsafe driving behavior based on characteristics of the unsafe driving behavior;
simulate candidate ego vehicle responses to the unsafe driving behavior based on:
a classification of the unsafe driving behavior; and
a profile of an ego vehicle driver; and
generate guidance for the ego vehicle based on a selected vehicle response.

2. The system of claim 1, wherein the machine-readable instruction that, when executed by the processor, causes the processor to classify the unsafe driving behavior further comprises a machine-readable instruction that, when executed by the processor, causes the processor to classify the unsafe driving behavior based on at least one of:
a type of the unsafe driving behavior;
a movement pattern of the unsafe driving behavior;
a degree of repetition of the unsafe driving behavior;
a temporal context of the unsafe driving behavior; or
a number of lanes affected.

3. The system of claim 1, wherein the machine-readable instruction that, when executed by the processor, causes the processor to simulate candidate ego vehicle responses to the unsafe driving behavior comprises a machine-readable instruction that, when executed by the processor, causes the processor to simulate candidate ego vehicle responses to the unsafe driving behavior based on surrogate measures of safety.

4. The system of claim 1, wherein the machine-readable instruction that, when executed by the processor, causes the processor to detect the unsafe driving behavior of the vehicle in the vicinity of the ego vehicle comprises a machine-readable instruction that, when executed by the processor, causes the processor to detect the unsafe driving behavior of the vehicle based on at least one of:
a sensor system of the ego vehicle; or
sensor systems of multiple vehicles in the vicinity of the vehicle.

5. The system of claim 1, wherein the machine-readable instruction that, when executed by the processor, causes the processor to simulate candidate ego vehicle responses to the unsafe driving behavior comprises a machine-readable instruction that, when executed by the processor, causes the processor to simulate the candidate ego vehicle responses based on at least one of:
a surrounding environment of the vehicle and the ego vehicle; or
characteristics of the vehicle.

6. The system of claim 1, wherein the machine-readable instruction that, when executed by the processor, causes the processor to simulate candidate ego vehicle responses to the unsafe driving behavior comprises a machine-readable instruction that, when executed by the processor, causes the processor to execute a digital twin simulation of the candidate ego vehicle responses to the unsafe driving behavior.

7. The system of claim 1, wherein the machine-readable instruction that, when executed by the processor, causes the processor to simulate candidate ego vehicle responses to the unsafe driving behavior comprises a machine-readable instruction that, when executed by the processor, causes the processor to predict an action of the vehicle based on:
a time-ordered sequence of detected maneuvers; and
the classification of the unsafe driving behavior.

8. The system of claim 1, wherein the machine-readable instructions further comprise a machine-readable instruction that, when executed by the processor, causes the processor to generate the profile of the ego vehicle driver based on at least one of:
manually input ego vehicle driver information;
ego vehicle sensor output; or
a profile of a similar driver.

9. The system of claim 1, wherein the machine-readable instruction that, when executed by the processor, causes the processor to simulate candidate ego vehicle responses to the unsafe driving behavior comprises a machine-readable instruction that, when executed by the processor, causes the processor to simulate candidate ego vehicle responses to the unsafe driving behavior based on historical behavior of other drivers in similar situations and resulting outcomes.

10. The system of claim 1, wherein:
the machine-readable instruction that, when executed by the processor, causes the processor to classify the unsafe driving behavior further comprises a machine-readable instruction that, when executed by the processor causes the processor to classify the unsafe driving behavior based on previously executed simulations; and
the machine-readable instruction that, when executed by the processor, causes the processor to simulate candidate ego vehicle responses based on an outcome associated with previously generated guidance.

11. The system of claim 1, wherein the machine-readable instruction that, when executed by the processor, causes the processor to generate guidance for the ego vehicle comprises a machine-readable instruction that, when executed by the processor, causes the processor to transmit the guidance to at least one of:
an automated driving system of the ego vehicle; or
a navigation system of the ego vehicle.

12. A non-transitory machine-readable medium comprising instructions that, when executed by a processor, cause the processor to:
detect an unsafe driving behavior of a vehicle in a vicinity of an ego vehicle;
classify the unsafe driving behavior based on characteristics of the unsafe driving behavior;
simulate candidate ego vehicle responses to the unsafe driving behavior based on:
a classification of the unsafe driving behavior; and
a profile of an ego vehicle driver; and
generate guidance for the ego vehicle based on a selected vehicle response.

13. The non-transitory machine-readable medium of claim 12, wherein the instruction that, when executed by the processor, causes the processor to classify the unsafe driving behavior further comprises an instruction that, when executed by the processor, causes the processor to classify the unsafe driving behavior based on at least one of:
a type of the unsafe driving behavior;
a movement pattern of the unsafe driving behavior;
a degree of repetition of the unsafe driving behavior;
a temporal context of the unsafe driving behavior; or
a number of lanes affected.

14. The non-transitory machine-readable medium of claim 12, wherein the instruction that, when executed by the processor, causes the processor to simulate candidate ego vehicle responses to the unsafe driving behavior further comprises an instruction that, when executed by the processor, causes the processor to simulate candidate ego vehicle responses to the unsafe driving behavior based on surrogate measures of safety.

15. The non-transitory machine-readable medium of claim 12, wherein the instructions that, when executed by the processor, causes the processor to simulate candidate ego vehicle responses to the unsafe driving behavior comprises an instruction that, when executed by the processor, causes the processor to simulate the candidate ego vehicle responses based on at least one of:
a surrounding environment of the vehicle and the ego vehicle; or
characteristics of the vehicle.

16. The non-transitory machine-readable medium of claim 12, wherein the instruction that, when executed by the processor, causes the processor to simulate candidate ego vehicle responses to the unsafe driving behavior comprises an instruction that, when executed by the processor, causes the processor to predict an action of the vehicle based on:
a time-ordered sequence of detected maneuvers; and
the classification of the unsafe driving behavior.

17. A method, comprising:
detecting an unsafe driving behavior of a vehicle in a vicinity of an ego vehicle;
classifying the unsafe driving behavior based on characteristics of the unsafe driving behavior;
simulating candidate ego vehicle responses to the unsafe driving behavior based on:
a classification of the unsafe driving behavior; and
a profile of an ego vehicle driver; and
generating guidance for the ego vehicle based on a selected vehicle response.

18. The method of claim 17, wherein classifying the unsafe driving behavior further comprises classifying the unsafe driving behavior based on at least one of:
a type of the unsafe driving behavior;
a movement pattern of the unsafe driving behavior;
a degree of repetition of the unsafe driving behavior;
a temporal context of the unsafe driving behavior; or
a number of lanes affected.

19. The method of claim 17, wherein generating guidance for the ego vehicle further comprises simulating candidate ego vehicle responses to the unsafe driving behavior based on surrogate measures of safety.

20. The method of claim 17, wherein simulating candidate ego vehicle responses to the unsafe driving behavior comprises simulating the candidate ego vehicle responses based on at least one of:
a surrounding environment of the vehicle and the ego vehicle; or
characteristics of the vehicle.
